(19) United States
(12) Patent Application Publication
(10) Pub. No.: US 2026/0100772 A1
(43) Pub. Date: Apr. 9, 2026

(54) Layer 1 Measurement Delay Beam Management

(71) Applicant: Apple Inc., Cupertino, CA (US)

(72) Inventors: Manasa RAGHAVAN, Sunnyvale, CA (US); Konstantinos SARRIGEORGIDIS, Los Gatos, CA (US); Jie CUI, San Jose, CA (US); Yang TANG, San Jose, CA (US); Xiang CHEN, Palo Alto, CA (US); Dawei ZHANG, Saratoga, CA (US)

(21) Appl. No.: 19/349,351

(22) Filed: Oct. 3, 2025

Related U.S. Application Data
(60) Provisional application No. 63/703,472, filed on Oct. 4, 2024.

(51) Int. Cl. H04B 17/318; H04B 7/06; H04W 76/28

(52) U.S. Cl. CPC H04B 17/328; H04B 7/0626; H04B 7/06952; H04W 76/28

(57) ABSTRACT

An apparatus configured to process, based on signaling from a network, a measurement configuration comprising a first set of beams and a number of sample measurements to be performed for each of the first set of beams and perform Layer 1 (L1) measurements for reference signals transmitted on each of the first set of beams, wherein measurement results for the reference signals comprise L1 Reference Signal Received Power (RSRP).

### PRIORITY/INCORPORATION BY REFERENCE

This application claims priority to U.S. Provisional Application Ser. No. 63/703,472 filed on Oct. 4, 2024 and entitled “Layer 1 Measurement Delay Beam Management,” the entirety of which is incorporated by reference herein.

### BACKGROUND

Artificial intelligence (AI) and/or machine learning (ML) processes, e.g., deep learning neural networks, convolutional neural networks, etc., may be used to augment operations for the air interface in a cellular radio access network (RAN), e.g., 5G New Radio (NR) RAN, 6G RAN, etc. The use cases of AI/ML for the air interface include beam management (BM).

### SUMMARY

Some example embodiments are related to an apparatus having processing circuitry coupled to memory, wherein the processing circuitry is configured to process, based on signaling from a network, a measurement configuration comprising a first set of beams and a number of sample measurements to be performed for each of the first set of beams and perform Layer 1 (L1) measurements for reference signals transmitted on each of the first set of beams, wherein measurement results for the reference signals comprise L1 Reference Signal Received Power (RSRP).

Other example embodiments are related to an apparatus having processing circuitry coupled to memory, wherein the processing circuitry is configured to generate, for transmission to a user equipment (UE), a measurement configuration comprising a first set of beams and a number of sample measurements to be performed for each of the first set of beams and generate reference signals to be transmitted to the UE on each of the first set of beams.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example arrangement for AI/ML beam management according to various example embodiments.

FIG. 5 shows tables defining measurement periods for beam measurements for Frequency Range 1 (FR1) and FR2 according to various example embodiments.

FIG. 6 shows a first example table showing a side condition, a number of samples to be measured and a measurement accuracy according to various example embodiments.

FIG. 7 shows a second example table showing a side condition, a number of samples to be measured and a measurement accuracy according to various example embodiments.

FIG. 8 shows a third example table showing a side condition, a number of samples to be measured and a measurement accuracy according to various example embodiments.

FIG. 9 shows an example timing diagram for a reporting delay of a set A of beams from a UE to a network according to various example embodiments.

FIG. 10 shows an example call flow diagram for AI/ML beam management according to various example embodiments.

### DETAILED DESCRIPTION

The example embodiments may be further understood with reference to the following description and the related appended drawings, wherein like elements are provided with the same reference numerals. The example embodiments relate to operations for artificial intelligence (AI)/machine learning (ML) beam management (BM). Specifically, the example embodiments relate to measurement parameters for beam measurements for AI/ML BM.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML functionalities similar to those described herein, e.g., 5G-Advanced network, 6G network, etc. Therefore, the 5G NR network as described herein may represent any type of network implementing AI/ML functionalities similar to the 5G NR network.

The example embodiments describe various aspects related to using AI/ML models for BM within a network. The aspects include a measurement delay and measurement accuracy for a set B of beams, e.g., the beams measured by the UE. The aspects also include a reporting delay for a set A of beams, e.g., the beams predicted by the AI/ML model. The example embodiments describe operations from the perspective of the UE and the network (e.g., base station). Each of these example embodiments will be described in greater detail below.

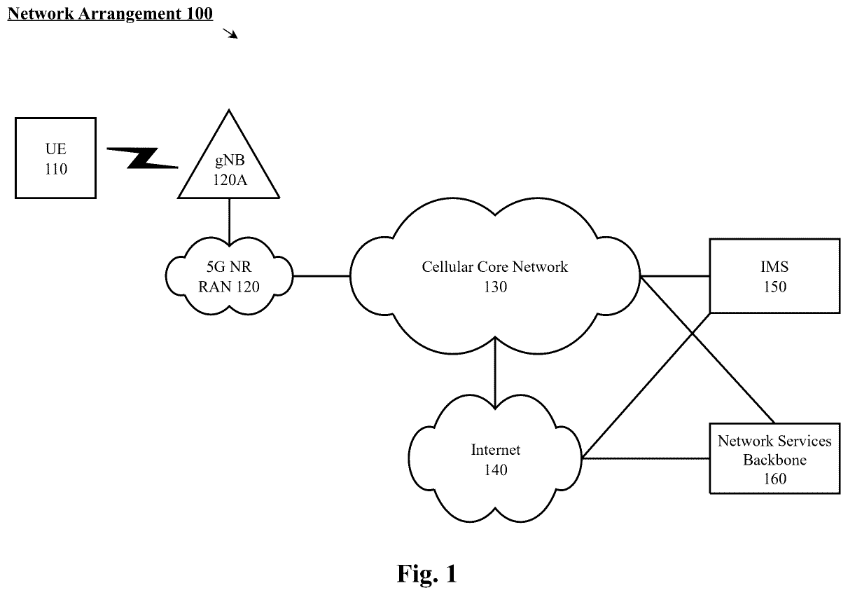

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution RAN, a legacy cellular network, a WLAN, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be a portion of a public land mobile network (PLMN) that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The gNB 120A may include one or more communication interfaces to exchange data and/or information with the UE 110, the corresponding 5G NR RAN 120, the cellular core network 130, the internet 140, etc.

The UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

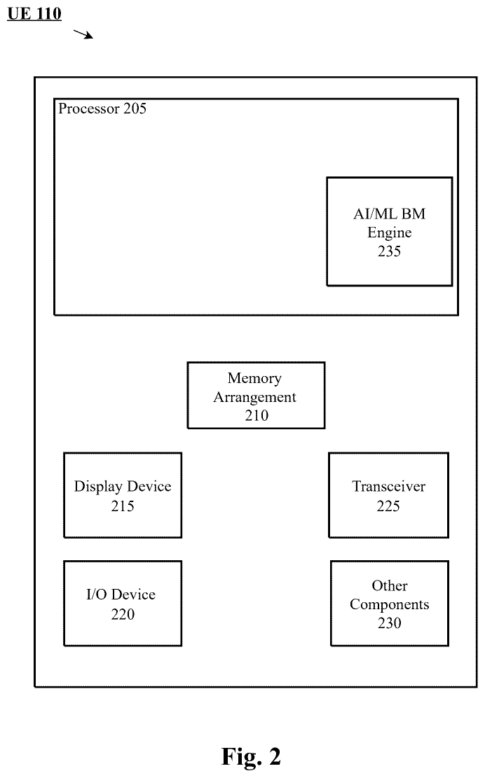

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an Artificial Intelligence/Machine Learning Beam Management (AI/ML BM) engine 235. The AI/ML BM engine 235 may perform various operations related to beam management. Specifically, the AI/ML BM engine 235 may perform operations such as, but not limited to, performing measurements on a first set of beams using a defined measurement delay and measurement accuracy, performing AI/ML inference to determine a second set of beams, reporting measurement results to the network for the first set of beams and reporting beam index and/or Reference Signal Received Power (RSRP) data for the second set of beams. These and other operations are described in greater detail below.

In some examples, measurement results on reference signals from downlink beam may be the input to the AI/ML BM engine 235. The AI/ML BM engine 235 may include one or more learning-based and/or non-learning-based models for perceiving, synthesizing, and inferring information. Persons skilled in the art will appreciate that the AI/ML BM engine 235 may include any suitable number of processes to beam management operations based on the measurement result inputs and other inputs described herein. Persons of ordinary skill in the art will appreciate that AI/ML BM engine 235 may include any suitable machine learning models that are well-known or widely available such as regression techniques, classification techniques, neural networks, and deep learning networks. In instances where AI/ML BM engine 235 comprises a machine-learning based model, AI/ML BM engine 235 may be trained to predict the “best” DL beams based on the measurement results of DL beams that are less than all available DL beams using one or more well-known or widely available training techniques such as supervised learning, semi-supervised learning, unsupervised learning, and/or reinforcement learning techniques. The training data may include the aforementioned measurement results over a period of time.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

In the example of FIG. 2, the processor 205 and the radio frequency (RF) circuitry (e.g., transceiver 225) are illustrated as separate components. However, in some example embodiments, the RF circuitry and the processing circuitry may be integrated into the same chip, e.g., a system on chip that includes a baseband processor and RF circuitry.

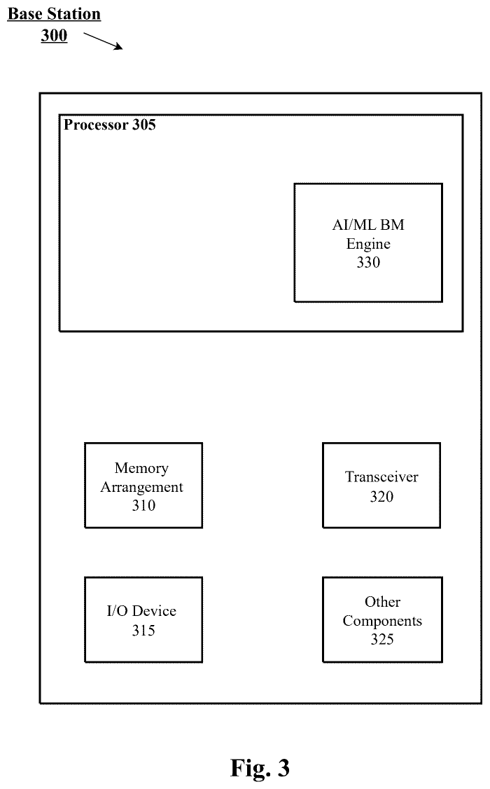

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include an AI/ML BM engine 330. The AI/ML BM engine 330 may perform various operations related to AI/ML BM operations and configuring a UE for AI/ML BM operations. These operations include, but are not limited to, determining channel conditions between the base station 300 and the UE, configuring a UE with parameters for measurement of a first set of beams based on the channel conditions, receiving measurement reports for the first set of beams, determining a second set of beams based on the measurement report, receiving a beam report including a beam index and/or RSRP information for a second set of beams and configuring the UE for UL and DL operations based on information for the second set of beams. These and other operations are described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

In the example of FIG. 3, the processor 305 and the radio frequency (RF) circuitry (e.g., transceiver 320) are illustrated as separate components. However, in some example embodiments, the RF circuitry and the processing circuitry may be integrated into the same chip, e.g., a system on chip that includes a baseband processor and RF circuitry.

In some examples, Set B measurements and other assumptions can be fed to AI/ML BM Engine 235 or AI/ML BM Engine 330. The AI/ML BM Engine 235 or AI/ML BM Engine 330 can include one or more learning-based and/or non-learning-based models for perceiving, synthesizing, and inferring information. Persons skilled in the art will appreciate that the [AI/ML BM Engine 235 or AI/ML BM Engine 330 can include any suitable number of processes to determine the Set A measurements.

Persons of ordinary skill in the art will appreciate that AI/ML BM Engine 235 or AI/ML BM Engine 330 can include any suitable machine learning models that are well-known or widely available such as regression techniques, classification techniques, neural networks, and deep learning networks. In instances where AI/ML BM Engine 235 or AI/ML BM Engine 330 comprises a machine-learning based model, AI/ML BM Engine 235 or AI/ML BM Engine 330 can be trained to generate the Set A measurements based on the Set B measurements and other inputs using one or more well-known or widely available training techniques such as supervised learning, semi-supervised learning, unsupervised learning, and/or reinforcement learning techniques.

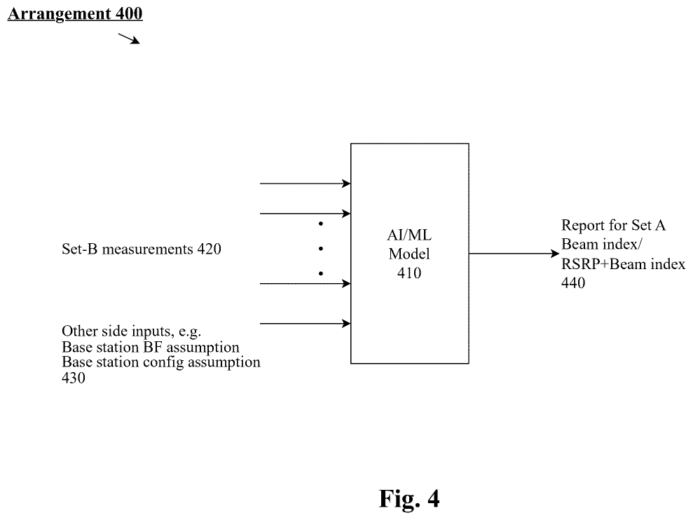

FIG. 4 shows an example arrangement 400 for AI/ML beam management according to various example embodiments. The arrangement 400 shows an AI/ML model 410 that is used for BM. The AI/ML model 410 may reside at the UE or at the network (e.g., base station).

As shown in FIG. 4, the input into the AI/ML model 410 may be measurements results 420 based on measurements performed by the UE on a set B of beams. The inputs may also include other inputs 430 such as beam forming assumptions and configuration assumptions used by a base station to transmit the set B of beams. The AI/ML model 410 uses these inputs 420 and 430 to predict a beam report 440 for a set A of beams. The beam report 440 may include, for example, beam indices for the set A of beams, Reference Signal Received Power (RSRP) for the set A of beams, etc. The beam report 440 for the set A of beams is not based on actual measurements on the set A of beams but is based on a prediction by the AI/ML model 410 using the inputs 420 and 430. The network may then use the information from the beam report to perform BM operations in the downlink (DL) such as changing a transmission configuration indicator (TCI) for DL transmissions. The AI/ML model 410 may be trained using any data and/or technique and the training of the AI/ML model 410 is beyond the scope of this disclosure.

In AI/ML based BM, the DL beam may be predicted in the spatial domain or in the temporal domain. As described above, the UE may measure a set B of beams and the AI/ML model 410 may perform the predictions for the set A of beams. In some examples, the set B of beams may be a subset of the beams that may be transmitted by the network. For example, the base station may be capable of transmitting 64 beams but the base station may only transmit 4 beams or 8 beams as the set B of beams. The AI/ML model 410 may then predict a larger set of beams, e.g., the set A of beams.

There may be multiple cases related to the AI/ML predictions. In a first case, the AI/ML model 410 may be resident on the UE and the UE may perform the prediction and report the set A of beams to the network. This reporting may include the beam index only, e.g., the beam index of the best beam of the set A of beams or a predefined number (K) of best beams of the set A of beams where K≥1. The “best” beam may be defined in any manner. For example, the best beam may be based on the predicted RSRP of the beams. The example embodiments are not limited to reporting the best beams.

In a second case, the AI/ML model 410 may be resident on the UE and the UE may perform the prediction and report the set A of beams to the network. This reporting may include the beam index and the RSRP corresponding to the beam index. Again, this reporting may be limited to the best beam of the set A of beams or a predefined number (K) of best beams of the set A of beams where K≥1. However, the example embodiments are not limited to reporting the best beams.

In a third case, the AI/ML model 410 may be resident on the network and the UE may report the set B measurements to the network so the network may perform the prediction for the set A of beams.

The example embodiments may relate to the spatial or temporal prediction and any of the cases described above. The example embodiments relate to the measurement requirements (e.g., measurement parameters and measurement reporting parameters) for measurements for AI/ML based BM. These measurement requirements may relate to layer 1 (L1) RSRP measurement delay and measurement accuracy as will be described in greater detail below. The L1 RSRP measurements may be performed on reference signals (e.g., Synchronization Signal Blocks (SSBs), Channel State Information Reference Signals (CSI-RS), etc.) transmitted by the set B of beams.

In some aspects, the example embodiments are related to the measurement accuracy for the set B of beams. The measurement accuracy of the L1 RSRP measurements of the set B of beams may affect the accuracy of the predictions made by the AI/ML model 410. Thus, more accurate L1 RSRP measurements may lead to better quality predictions by the AI/ML model 410.

In some example embodiments, a fixed number of samples (L) for measurement is defined such that L>1, e.g., multiple samples are used to increase accuracy. The value of L may be, for example, 3 samples, 5 samples, etc. The values of 3 and 5 are only examples and other values may be used. The value of L may be configured by the network in a measurement configuration for the set B of beams provided to the UE, e.g., in Radio Resource Control (RRC) signaling.

In other example embodiments, the number of samples (L) may be variable. For example, the network may configure the value of L based on various factors, for example, the Signal to Interference Noise Ratio (SINR), a deployment scenario, etc. In these example embodiments, the network may configure the UE with a set of L values in the RRC signaling of the measurement configuration for the set B of beams. Then, Medium Access Control Control Element (MAC CE) or Downlink Control Information (DCI) signaling may be used by the network to select one of the configured set of L values based on the conditions being experienced by the UE. In these example embodiments, when the UE is experiencing good channel conditions, e.g., high signal to noise ratio (SNR) conditions based on UL measurements, the network may set the L value to 1 because in the good channel condition scenario, the network may determine that the L1 RSRP measurements should be accurate. Whereas, in low SNR conditions, the network may set the L value to a higher value to compensate for the potentially lower accuracy L1 RSRP measurements.

In some example embodiments, when the UE is operating according to the third case, e.g., the AI/ML model 410 may be resident on the network and the UE may report the set B measurements to the network, the UE may be provided with a measurement accuracy. This measurement accuracy may be based on a value of L and a side condition, e.g., SNR.

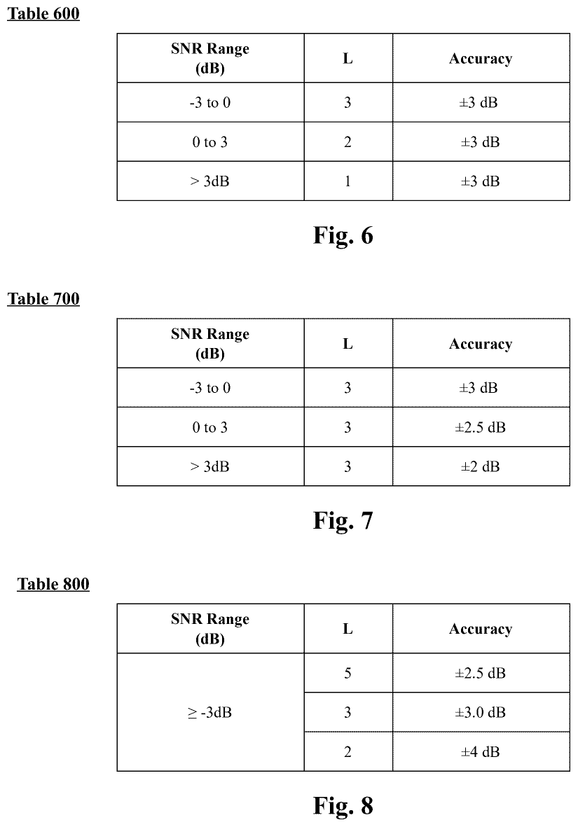

FIG. 6 shows a first example table 600 showing a side condition, a number of samples to be measured and a measurement accuracy according to various example embodiments. As stated above, in these example embodiments, the UE is reporting the measurement results to the network.

In this example, the side condition is SNR and the measurement accuracy is ±3 dB. To meet this measurement accuracy, the value of L may be set based on the SNR. For example, when the SNR is in the range of −3-0 dB, the value of L is 3, e.g., more measurement samples when the SNR is worse. When the SNR is in the range of 0-3 dB, the value of L is 2. When the SNR is >3 dB, the value of L is 1, e.g., the UE is experiencing good channel conditions and a single sample will achieve the target accuracy of ±3 dB. The values in the table 600 are only an example used to illustrate the example that the value of L and the associated side condition may be set to achieve the same accuracy under the differing channel conditions.

FIG. 7 shows a second example table 700 showing a side condition, a number of samples to be measured and a measurement accuracy according to various example embodiments. As stated above, in these example embodiments, the UE is reporting the measurement results to the network.

In this example, the side condition is SNR and the value of L is fixed, e.g., 3 resulting in different measurement accuracies. For example, when the SNR is in the range of −3-0 dB and the value of L is 3, the measurement accuracy is ±3 dB. When the SNR is in the range of 0-3 dB and the value of L is 3, the measurement accuracy is ±2.5 dB. When the SNR is >3 dB and the value of L is 3, the measurement accuracy is ±2 dB. The values in the table 700 are only an example used to illustrate the example that when the value of L is fixed, the accuracy varies according to differing channel conditions.

FIG. 8 shows a third example table 800 showing a side condition, a number of samples to be measured and a measurement accuracy according to various example embodiments. As stated above, in these example embodiments, the UE is reporting the measurement results to the network.

This example may apply to all values of the SNR side condition, e.g., SNR≥−3 dB. As the value of L varies, the measurement accuracy may vary. For example, when the value of L is 5, the measurement accuracy is ±2.5 dB. When the value of L is 3, the measurement accuracy is ±3.0 dB. When the value of L is 2, the measurement accuracy is ±4 dB. The values in the table 800 are only an example used to illustrate the example that when the value of L is variable for any SNR value, the accuracy varies according to the number of samples measured.

In a variation of the example of FIG. 8, when the value of L is fixed, the measurement accuracy may be the same for all SNRs, e.g., SNR≥−3 dB; L=3; Accuracy±3.0 dB.

In another aspect, the example embodiments relate to the measurement delay for the set B of beams. In these example embodiments, all beams of the set B of beams are transmitted using Time Division Multiplexing (TDM), e.g., the beams do not overlap in time. The measurement period may cover measurement of all beams in of the set B of beams and the beams may be transmitted with a same periodicity with different time offsets/SSB index.

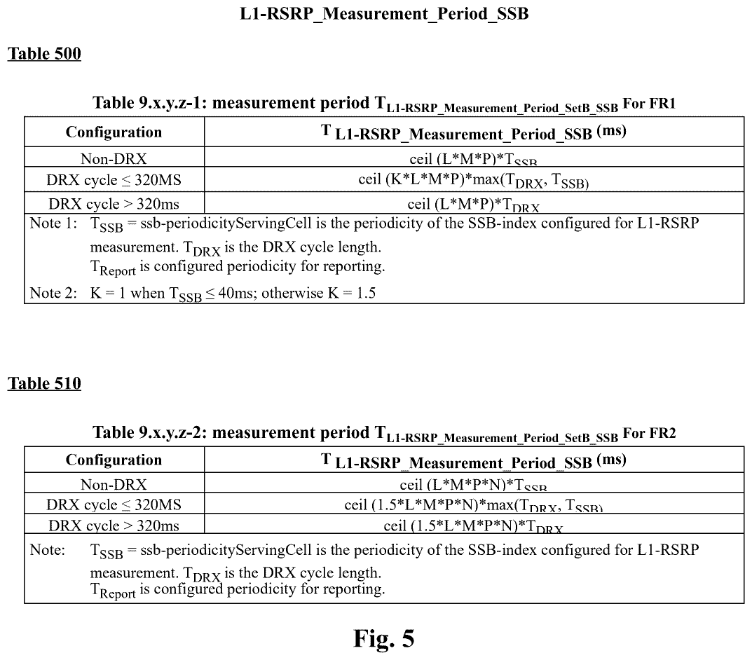

FIG. 5 shows tables defining measurement periods for beam measurements for Frequency Range 1 (FR1) and FR2 according to various example embodiments. The table 500 shows the measurement periods for FR1 and the table 510 shows the measurement periods for FR2. The UE continuously performs the measurements on the set B of beams. The measurements may be performed on SSB or CSI-RS transmitted by the beams. In the example tables of FIG. 5, the measurement periods are for SSB measurements, e.g., T_{L1-RSRP_Measurement_Period_SetB_SSB}). However, similar tables may be provided for CSI-RS measurement periods.

In the tables, M is the number of samples for measurement, e.g., number of beams to be measured. L is the number of samples per beam as described above. P is a sharing factor P that may be predefined by standard (e.g., 3GPP standards) or a value indicated to the UE in signaling from the network. The value K may be a predefined factor having a value defined by standard (e.g., 3GPP standards) or a value indicated to the UE in signaling from the network. N is a beam sweeping factor having a value defined by standard (e.g., 3GPP standards) or a value indicated to the UE in signaling from the network.

The example embodiments also relate to the reporting delay for the set A of beams. For example, when the UE performs the prediction (e.g., the AI/ML model 410 is resident on the UE), the UE then reports the predicted set A of beams to the network, e.g., the report comprising the beam indices, the RSRP, etc. However, there may be a delay associated with this reporting as will be described in greater detail below.

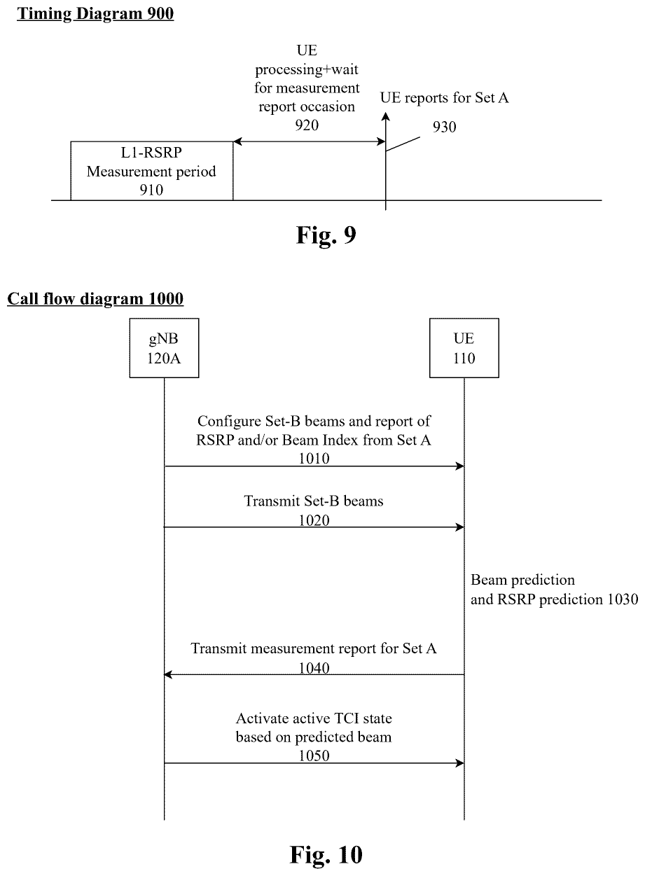

FIG. 9 shows an example timing diagram 900 for a reporting delay of a set A of beams from a UE to a network according to various example embodiments. During the time 910, the UE may perform the L1-RSRP measurements on the reference signals transmitted on the set B of beams. The time 910 may be, for example, the measurement period described above with reference to FIG. 5.

Once the UE has the measurements for the set B of beams, e.g., the input to the AI/ML model 410, the UE, during time 920 may perform the processing to determine the set A of beams. This may include the predictions of the AI/ML model and determining the K best beams, etc. However, the time 920 may also include time to wait for a next measurement reporting occasion to send the report to the network. For example, the measurement configuration for the set B of beams (or another configuration) may also include one or more reporting occasions for the UE to report the set A of beams to the network. The reporting occasions may be periodic (e.g., based on T_{REPORT} that is a configured periodicity for reporting) or aperiodic (e.g., based on information in the DCI triggering the report).

Thus, at 930, the reporting occasion may occur and the UE may report the set A of beams to the network.

FIG. 10 shows an example call flow diagram 1000 for AI/ML beam management according to various example embodiments. The call flow 100 may be performed between the gNB 120A and UE 110 of the network arrangement 100 of FIG. 1. In this example, the AI/ML model is resident on the UE 110.

In 1010, the gNB 120A configures the UE with the set B of beams and associated reporting for the set A of beams. For example, the reporting may include the beam index of the best K beams of set A or the beam index and RSRP value for best K beams of set A.

In 1020, the gNB 120A may transmit the set B of beams including reference signals, e.g., SSBs, CSI-RS, etc. The UE 110 may perform L1-RSRP measurements on the reference signals in the set B of beams. As described above, the measurement parameters may include a measurement period for the measurements, a number of samples (L) for each measurement, etc.

In 1030, the UE 110 may perform the beam prediction to generate the set A of beams based on the set B measurement results and any other inputs to the AI/ML model resident on the UE. As described above, the UE 110 may determine the best K beams (e.g., where K≥1) for the set A.

In 1040, after the measurement period and the processing time for the AI/ML model to make the predictions, the UE 110 may report the set A of beams to the gNB 120A in the next available reporting occasion.

In 1050, the gNB 120A may activate a TCI state for the UE 110 based on the predicted set A of beams, e.g., the reported best K beams.

### Examples

In a first example, a method, comprising processing, based on signaling from a network, a measurement configuration comprising a first set of beams and a number of sample measurements to be performed for each of the first set of beams and performing Layer 1 (L1) measurements for reference signals transmitted on each of the first set of beams, wherein measurement results for the reference signals comprise L1 Reference Signal Received Power (RSRP).

In a second example, the method of the first example, wherein the number of sample measurements to be performed for each of the first set of beams comprises a fixed value.

In a third example, the method of the first example, wherein the number of sample measurements to be performed for each of the first set of beams comprises a set of values, wherein the method further comprises processing, based on signaling from the network, a selection of one of the set of values.

In a fourth example, the method of the third example, wherein the measurement configuration is received via Radio Resource Control (RRC) signaling and the selection is received via one of Medium Access Control Control Element (MAC CE) signaling or Downlink Control Indication (DCI) signaling.

In a fifth example, the method of the first example, wherein the measurement configuration is received via Radio Resource Control (RRC) signaling.

In a sixth example, the method of the first example, wherein the reference signals comprise one of Synchronization Signal Blocks (SSBs) or Channel State Information Reference Signals (CSI-RS).

In a seventh example, the method of the first example, wherein the reference signals are measured during a measurement period based on at least a type of the reference signals and a frequency range in which the reference signals are transmitted, wherein the frequency range comprises one of Frequency Range 1 (FR1) or Frequency Range 2 (FR2).

In an eighth example, the method of the seventh example, wherein, when the reference signals are Synchronization Signal Blocks (SSBs) and the frequency range is FR1, the measurement period is further determined based on whether the apparatus is operating in a discontinuous reception (DRX) cycle, wherein, when not operating in a discontinuous reception (DRX) cycle, the measurement period is determined based on ceil (L*M*P)*T_{SSB}), when operating in accordance with a DRX cycle length not more than 320 milliseconds, the measurement period is determined based on ceil (K*L*M*P)*max (T_{DRX}, T_{SSB}) and when operating in accordance with a DRX cycle length greater than 320 milliseconds, the measurement period is determined based on ceil (L*M*P)*T_{DRX}, wherein M is a number of beams in the first set, L is the number of sample measurements to be performed for each of the first set of beams, P is a sharing factor, K is a predefined factor, T_{SSB} is a periodicity of the SSBs, and T_{DRX} is the DRX cycle length.

In a ninth example, the method of the seventh example, wherein, when the reference signals are Synchronization Signal Blocks (SSBs) and the frequency range is FR2, the measurement period is further determined based on whether the apparatus is operating in a discontinuous reception (DRX) cycle, wherein, when not operating in a discontinuous reception (DRX) cycle, the measurement period is determined based on ceil (L*M*P*N)*T_{SSB}), when operating in accordance with a DRX cycle length not more than 320 milliseconds, the measurement period is determined based on ceil (1.5*L*M*P*N)*max (T_{DRX}, T_{SSB}) and when operating in accordance with a DRX cycle length greater than 320 milliseconds, the measurement period is determined based on ceil (1.5*L*M*P*N)*T_{DRX}, wherein M is a number of beams in the first set, L is the number of sample measurements to be performed for each of the first set of beams, P is a sharing factor, N is a beam sweeping factor, T_{SSB} is a periodicity of the SSBs, and T_{DRX} is the DRX cycle length.

In a tenth example, the method of the seventh example, wherein, when the reference signals are Channel State Information Reference Signals (CSI-RS) and the frequency range is FR1, the measurement period is further determined based on whether the apparatus is operating in a discontinuous reception (DRX) cycle, wherein, when not operating in a discontinuous reception (DRX) cycle, the measurement period is determined based on ceil (L*M*P)*T_{CSI-RS}), when operating in accordance with a DRX cycle length not more than 320 milliseconds, the measurement period is determined based on ceil (K*L*M*P)*max (T_{DRX}, T_{CSI-RS}) and when operating in accordance with a DRX cycle length greater than 320 milliseconds, the measurement period is determined based on ceil (L*M*P)*T_{DRX}, wherein M is a number of beams in the first set, L is the number of sample measurements to be performed for each of the first set of beams, P is a sharing factor, K is a predefined factor, T_{CSI-RS} is a periodicity of the CSI-RS, and T_{DRX} is the DRX cycle length.

In an eleventh example, the method of the seventh example 7, wherein, when the reference signals are Channel State Information Reference Signals (CSI-RS) and the frequency range is FR2, the measurement period is further determined based on whether the apparatus is operating in a discontinuous reception (DRX) cycle, wherein, when not operating in a discontinuous reception (DRX) cycle, the measurement period is determined based on ceil (L*M*P*N)*T_{CSI-RS}), when operating in accordance with a DRX cycle length not more than 320 milliseconds, the measurement period is determined based on ceil (1.5*L*M*P*N)*max (T_{DRX}, T_{CSI-RS}) and when operating in accordance with a DRX cycle length greater than 320 milliseconds, the measurement period is determined based on ceil (1.5*L*M*P*N)*T_{DRX}, wherein M is a number of beams in the first set, L is the number of sample measurements to be performed for each of the first set of beams, P is a sharing factor, N is a beam sweeping factor, T_{CSI-RS} is a periodicity of the CSI-RS, and T_{DRX} is the DRX cycle length.

In a twelfth example, the method of the first example, further comprising generating, for transmission to the network, a measurement report comprising the measurement results for the first set of beams.

In a thirteenth example, the method of the twelfth example, wherein a measurement accuracy for the measurement results is based on a value of the number of sample measurements to be performed for each of the first set of beams being set based on a signal to noise ratio (SNR) of a channel between the apparatus and the network, wherein the value results in a same measurement accuracy for all SNRs.

In a fourteenth example, the method of the twelfth example, wherein a measurement accuracy for the measurement results is based on a fixed value of the number of sample measurements to be performed for each of the first set of beams and a signal to noise ratio (SNR) of a channel between the apparatus and the network, wherein the measurement accuracy is based on a range of the SNR.

In a fifteenth example, the method of the twelfth example, wherein a measurement accuracy for the measurement results is based on a value of the number of sample measurements to be performed for each of the first set of beams and a signal to noise ratio (SNR) of a channel between the apparatus and the network, wherein different values result in a different measurement accuracy for all SNRs.

In a sixteenth example, the method of the twelfth example, wherein a measurement accuracy for the measurement results is based on a fixed value of the number of sample measurements to be performed for each of the first set of beams and a signal to noise ratio (SNR) of a channel between the apparatus and the network, wherein the fixed value results in a same measurement accuracy for all SNRs.

In a seventeenth example, the method of the first example, further comprising determining, based on the measurement results for the first set of beams, a predicted RSRP for a second set of beams and generating, for transmission to the network, a measurement report comprising the second set of beams.

In an eighteenth example, the method of the seventeenth example, wherein the measurement report comprises one of (a) a beam index for one or more of the second set of beams, or (b) the predicted RSRP and corresponding beam index for one or more of the second set of beams.

In a nineteenth example, the method of the seventeenth example, wherein the measurement report is transmitted during a first report occasion that occurs after a measurement period corresponding to performing the L1 measurements and a processing time to determine the predicted RSRP for the second set of beams.

In a twentieth example, a processor configured to perform any of the methods of the first through nineteenth examples.

In a twenty first example, a user equipment configured to perform any of the methods of the first through nineteenth examples.

In a twenty second example, a method, comprising generating, for transmission to a user equipment (UE), a measurement configuration comprising a first set of beams and a number of sample measurements to be performed for each of the first set of beams and generating reference signals to be transmitted to the UE on each of the first set of beams.

In a twenty third example, the method of the twenty second example, wherein the number of sample measurements to be performed for each of the first set of beams comprises a fixed value.

In a twenty fourth example, the method of the twenty second example, wherein the number of sample measurements to be performed for each of the first set of beams comprises a set of values, wherein the method further comprises determining a signal to interference noise ratio (SINR) for a channel between the apparatus and the UE and generating, for transmission to the UE, a selection of one of the set of values based on the SINR.

In a twenty fifth example, the method of the twenty fourth example, wherein the measurement configuration is transmitted via Radio Resource Control (RRC) signaling and the selection is transmitted via one of Medium Access Control Control Element (MAC CE) signaling or Downlink Control Indication (DCI) signaling.

In a twenty sixth example, the method of the twenty second example, wherein the measurement configuration is transmitted via Radio Resource Control (RRC) signaling.

In a twenty seventh example, the method of the twenty second example, wherein the reference signals comprise one of Synchronization Signal Blocks (SSBs) or Channel State Information Reference Signals (CSI-RS).

In a twenty eighth example, the method of the twenty second example, further comprising processing, based on signaling from the UE, a measurement report comprising the measurement results for the first set of beams.

In a twenty ninth example, the method of the twenty eighth example, wherein a measurement accuracy for the measurement results is based on a value of the number of sample measurements to be performed for each of the first set of beams being set based on a signal to noise ratio (SNR) of a channel between the apparatus and the UE, wherein the value results in a same measurement accuracy for all SNRs.

In a thirtieth example, the method of the twenty eighth example, wherein a measurement accuracy for the measurement results is based on a fixed value of the number of sample measurements to be performed for each of the first set of beams and a signal to noise ratio (SNR) of a channel between the apparatus and the UE, wherein the measurement accuracy is based on a range of the SNR.

In a thirty first example, the method of the twenty eighth example, wherein a measurement accuracy for the measurement results is based on a value of the number of sample measurements to be performed for each of the first set of beams and a signal to noise ratio (SNR) of a channel between the apparatus and the UE, wherein different values result in a different measurement accuracy for all SNRs.

In a thirty second example, the method of the twenty eighth example, wherein a measurement accuracy for the measurement results is based on a fixed value of the number of sample measurements to be performed for each of the first set of beams and a signal to noise ratio (SNR) of a channel between the apparatus and the UE, wherein the fixed value results in a same measurement accuracy for all SNRs.

In a thirty third example, the method of the twenty second example, further comprising processing, based on signaling from the UE, a measurement report comprising a second set of beams.

In a thirty fourth example, the method of the thirty third example, wherein the measurement report comprises one of (a) a beam index for one or more of the second set of beams, or (b) the predicted RSRP and corresponding beam index for one or more of the second set of beams.

In a thirty fifth example, a processor configured to perform any of the methods of the twenty second through thirty fourth examples.

In a thirty sixth example, a base station configured to perform any of the methods of the twenty second through thirty fourth examples.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data.

For example, the data can be used to train models that can be deployed to improve performance, accuracy, and/or functionality of applications and/or services. Accordingly, the use of the data enables the AI/ML BM engine 235 or the AI/ML BM engine 330 to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML BM engine 235 or the AI/ML BM engine 330 are also contemplated by the present disclosure.

The present disclosure contemplates that, in some embodiments, data used by AI/ML BM engine 235 or the AI/ML BM engine 330 includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML BM engine 235 or the AI/ML BM engine 330, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, wherein the processing circuitry is configured to:
process, based on signaling from a network, a measurement configuration comprising a first set of beams and a number of sample measurements to be performed for each of the first set of beams; and
perform Layer 1 (L1) measurements for reference signals transmitted on each of the first set of beams, wherein measurement results for the reference signals comprise L1 Reference Signal Received Power (RSRP).

2. The apparatus of claim 1, wherein the number of sample measurements to be performed for each of the first set of beams comprises a fixed value.

3. The apparatus of claim 1, wherein the number of sample measurements to be performed for each of the first set of beams comprises a set of values, wherein the processing circuitry is further configured to:
process, based on signaling from the network, a selection of one of the set of values.

4. The apparatus of claim 3, wherein the measurement configuration is received via Radio Resource Control (RRC) signaling and the selection is received via one of Medium Access Control Control Element (MAC CE) signaling or Downlink Control Indication (DCI) signaling.

5. The apparatus of claim 1, wherein the reference signals comprise one of Synchronization Signal Blocks (SSBs) or Channel State Information Reference Signals (CSI-RS).

6. The apparatus of claim 1, wherein the reference signals are measured during a measurement period based on at least a type of the reference signals and a frequency range in which the reference signals are transmitted, wherein the frequency range comprises one of Frequency Range 1 (FR1) or Frequency Range 2 (FR2).

7. The apparatus of claim 6, wherein, when the reference signals are Synchronization Signal Blocks (SSBs) and the frequency range is FR1, the measurement period is further determined based on whether the apparatus is operating in a discontinuous reception (DRX) cycle, wherein
when not operating in a discontinuous reception (DRX) cycle, the measurement period is determined based on ceil (L*M*P)*T_{SSB});
when operating in accordance with a DRX cycle length not more than 320 milliseconds, the measurement period is determined based on ceil (K*L*M*P)*max (T_{DRX}, T_{SSB}); and
when operating in accordance with a DRX cycle length greater than 320 milliseconds, the measurement period is determined based on ceil (L*M*P)*T_{DRX},
wherein M is a number of beams in the first set, L is the number of sample measurements to be performed for each of the first set of beams, P is a sharing factor, K is a predefined factor, T_{SSB} is a periodicity of the SSBs, and T_{DRX} is the DRX cycle length.

8. The apparatus of claim 6, wherein, when the reference signals are Synchronization Signal Blocks (SSBs) and the frequency range is FR2, the measurement period is further determined based on whether the apparatus is operating in a discontinuous reception (DRX) cycle, wherein
when not operating in a discontinuous reception (DRX) cycle, the measurement period is determined based on ceil (L*M*P*N)*T_{SSB});
when operating in accordance with a DRX cycle length not more than 320 milliseconds, the measurement period is determined based on ceil (1.5*L*M*P*N)*max (T_{DRX}, T_{SSB}); and
when operating in accordance with a DRX cycle length greater than 320 milliseconds, the measurement period is determined based on ceil (1.5*L*M*P*N)*T_{DRX},
wherein M is a number of beams in the first set, L is the number of sample measurements to be performed for each of the first set of beams, P is a sharing factor, N is a beam sweeping factor, T_{SSB} is a periodicity of the SSBs, and T_{DRX} is the DRX cycle length.

9. The apparatus of claim 6, wherein, when the reference signals are Channel State Information Reference Signals (CSI-RS) and the frequency range is FR1, the measurement period is further determined based on whether the apparatus is operating in a discontinuous reception (DRX) cycle, wherein
when not operating in a discontinuous reception (DRX) cycle, the measurement period is determined based on ceil (L*M*P)*T_{CSI-RS});
when operating in accordance with a DRX cycle length not more than 320 milliseconds, the measurement period is determined based on ceil (K*L*M*P)*max (T_{DRX}, T_{CSI-RS}); and
when operating in accordance with a DRX cycle length greater than 320 milliseconds, the measurement period is determined based on ceil (L*M*P)*T_{DRX},
wherein M is a number of beams in the first set, L is the number of sample measurements to be performed for each of the first set of beams, P is a sharing factor, K is a predefined factor, T_{CSI-RS} is a periodicity of the CSI-RS, and T_{DRX} is the DRX cycle length.

10. The apparatus of claim 6, wherein, when the reference signals are Channel State Information Reference Signals (CSI-RS) and the frequency range is FR2, the measurement period is further determined based on whether the apparatus is operating in a discontinuous reception (DRX) cycle, wherein
when not operating in a discontinuous reception (DRX) cycle, the measurement period is determined based on ceil (L*M*P*N)*T_{CSI-RS});
when operating in accordance with a DRX cycle length not more than 320 milliseconds, the measurement period is determined based on ceil (1.5*L*M*P*N)*max (T_{DRX}, T_{CSI-RS}); and
when operating in accordance with a DRX cycle length greater than 320 milliseconds, the measurement period is determined based on ceil (1.5*L*M*P*N)*T_{DRX},
wherein M is a number of beams in the first set, L is the number of sample measurements to be performed for each of the first set of beams, P is a sharing factor, N is a beam sweeping factor, T_{CSI-RS} is a periodicity of the CSI-RS, and T_{DRX} is the DRX cycle length.

11. The apparatus of claim 1, wherein the processing circuitry is configured to:
generate, for transmission to the network, a measurement report comprising the measurement results for the first set of beams.

12. The apparatus of claim 11, wherein a measurement accuracy for the measurement results is based on a value of the number of sample measurements to be performed for each of the first set of beams being set based on a signal to noise ratio (SNR) of a channel between the apparatus and the network, wherein the value results in a same measurement accuracy for all SNRs.

13. The apparatus of claim 11, wherein a measurement accuracy for the measurement results is based on a fixed value of the number of sample measurements to be performed for each of the first set of beams and a signal to noise ratio (SNR) of a channel between the apparatus and the network, wherein the measurement accuracy is based on a range of the SNR.

14. The apparatus of claim 11, wherein a measurement accuracy for the measurement results is based on a value of the number of sample measurements to be performed for each of the first set of beams and a signal to noise ratio (SNR) of a channel between the apparatus and the network, wherein different values result in a different measurement accuracy for all SNRs.

15. The apparatus of claim 11, wherein a measurement accuracy for the measurement results is based on a fixed value of the number of sample measurements to be performed for each of the first set of beams and a signal to noise ratio (SNR) of a channel between the apparatus and the network, wherein the fixed value results in a same measurement accuracy for all SNRs.

16. An apparatus comprising processing circuitry coupled to memory, wherein the processing circuitry is configured to:
generate, for transmission to a user equipment (UE), a measurement configuration comprising a first set of beams and a number of sample measurements to be performed for each of the first set of beams; and
generate reference signals to be transmitted to the UE on each of the first set of beams.

17. The apparatus of claim 16, wherein the number of sample measurements to be performed for each of the first set of beams comprises a fixed value.

18. The apparatus of claim 16, wherein the number of sample measurements to be performed for each of the first set of beams comprises a set of values, wherein the processing circuitry is further configured to:
determine a signal to interference noise ratio (SINR) for a channel between the apparatus and the UE; and
generate, for transmission to the UE, a selection of one of the set of values based on the SINR.

19. The apparatus of claim 16, wherein the reference signals comprise one of Synchronization Signal Blocks (SSBs) or Channel State Information Reference Signals (CSI-RS).

20. The apparatus of claim 16, wherein the processing circuitry is configured to:
process, based on signaling from the UE, a measurement report comprising the measurement results for the first set of beams.
